(19) United States
(12) Patent Application Publication
(10) Pub. No.: US 2026/0271971 A1
(43) Pub. Date: Sep. 17, 2026

(54) METHOD AND SYSTEM FOR PRODUCING COCONUT WATER BEVERAGES

(71) Applicant: Epic Brewing Company, LLC, Salt Lake City, UT (US)

(72) Inventors: David Wayne Cole, Carlsbad, CA (US); Richard Clayton Turnbow, Salt Lake City, UT (US); Jordan Schupbach, Dummerston, VT (US)

(73) Assignee: Epic Brewing Company, LLC, Salt Lake City, UT (US)

(21) Appl. No.: 19/077,609

(22) Filed: Mar. 12, 2025

(51) Int. Cl. A23L 2/04; A23B 70/10; A23B 70/30; A23L 2/54; A23L 2/68; A23L 2/72

(52) U.S. Cl. CPC A23L 2/04; A23B 70/10; A23B 70/30; A23L 2/54; A23L 2/68; A23L 2/72

(57) ABSTRACT

In accordance with the described techniques, a method for producing a coconut water beverage includes steeping coconut solids in water to extract coconut flavor. The water and extracted coconut flavor are filtered from the coconut solids to provide a filtered liquid. The filtered liquid is then pasteurized or sterilized to produce the coconut water beverage. The method may further include adjusting the water pH, rinsing the coconut solids with additional heated water, adding salt, and packaging the final beverage.

### BACKGROUND

Coconut water has gained popularity as a natural, refreshing beverage. Traditional methods of obtaining coconut water often involve harvesting and processing fresh coconuts, which can be resource-intensive and limit availability in regions where coconuts are not locally grown. For example, transporting coconut water from tropical areas to global markets presents logistical challenges and contributes to increased carbon emissions. Furthermore, the shelf life of fresh coconut water is relatively short, necessitating rapid distribution and consumption.

### SUMMARY

A method and system for producing a coconut water beverage is described. The techniques involve steeping dry coconut solids, such as coconut flakes, in heated water to extract coconut flavor and some nutritional components (e.g., sugar, fiber, and/or minerals). The steeping allows for the efficient extraction of coconut flavor compounds while leaving behind much of the natural sugars and calories in natural coconut water. The steeped mixture is then filtered to separate the liquid from the coconut solids, producing a flavorful coconut-infused liquid, which is subsequently pasteurized or sterilized to create a shelf-stable coconut water beverage.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities, and thus, reference is made interchangeably to single or plural forms of the entities in the discussion.

FIG. 1 is a schematic diagram of an example brewing system for producing coconut water beverages.

FIG. 2 is a flowchart depicting an example method for brewing coconut water.

### DETAILED DESCRIPTION

### Overview

Coconut water has gained popularity recently, but its production and distribution face several challenges. Traditional techniques for obtaining coconut water involve harvesting and processing fresh coconuts, which can be resource-intensive and geographically limited. To this end, coconut water distribution includes long-distance transportation of coconut water from tropical regions to global markets, contributing to increased carbon emissions, relatively high costs, and logistical complexities.

Existing production and distribution techniques for coconut water rely on extracting water from fresh coconuts or processing and packaging coconut water near the source. These traditional techniques often result in products with a relatively short shelf life, requiring rapid distribution and consumption. Additionally, the natural sugar content of coconut water may not align with consumer preferences for lower-calorie options, limiting its appeal to some health-conscious individuals.

Consumers are increasingly seeking products that offer the flavor and benefits of coconut water while aligning with their dietary preferences and environmental concerns. Furthermore, there is a demand for locally produced options that reduce the carbon footprint associated with long-distance transportation or are more economical.

Accordingly, the described brewing techniques for coconut water beverages address issues of sustainability, accessibility, and nutritional customization. For example, the coconut beverage is a low-calorie coconut water beverage brewed from dry coconut solids, such as coconut flakes. The described techniques include steeping the dry coconut solids in heated water to extract coconut flavor, followed by filtration and sterilization processes. The produced coconut beverage significantly reduces calorie and sugar content compared to natural coconut water, typically ranging from 70% to 90% less.

The described techniques for coconut water beverages enable local production, reducing the reliance on fresh coconuts and minimizing the environmental impact and costs of long-distance shipping. These brewing techniques allow for easy customization of the final product, including adjustments to calorie and sugar levels or adding flavors and other ingredients. By addressing the challenges of traditional coconut water production and distribution, these described techniques offer a more sustainable and versatile approach to meeting consumer demand for coconut water beverages.

The following discussion describes an example environment that employs the techniques described herein. Example procedures are also described as performable in the example environment and other environments. Consequently, the performance of the example procedures is not limited to the example environment, and the example environment is not limited to the performance of the example procedures.

### Example Brewing System

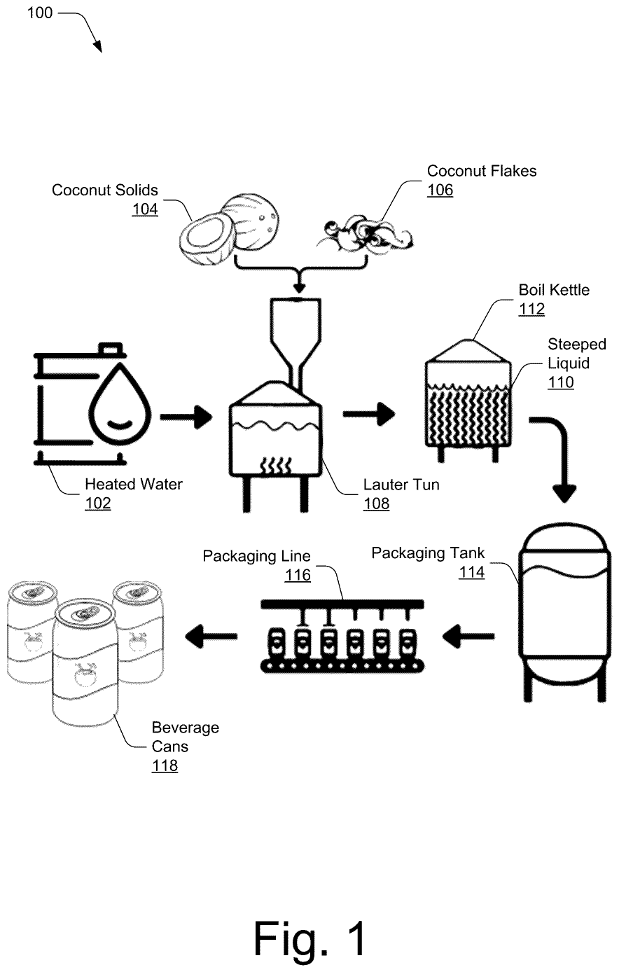

FIG. 1 is a schematic diagram of an example brewing system 100 for producing coconut water beverages. The brewing system 100 includes several components for producing coconut water beverages, including a heated water source 102, a lauter tun 108, a boil kettle 112, a packaging tank 114, and a packaging line. In other implementations, the brewing system 100 may include fewer or additional components, such as pasteurization during packaging or post-packaging pasteurization, without deviating from the scope of the described techniques for producing coconut water beverages.

The brewing system 100 may undergo a thorough cleaning and sterilization process before each production cycle. In some scenarios, the equipment is cleaned using a combination of high-pressure hot water rinses and food-grade sanitizing agents. The heated water source 102, lauter tun 108, boil kettle 112, and packaging tank 114 may be subjected to a clean-in-place (CIP) system, which circulates cleaning solutions through the vessels and associated piping. UV light sterilization can be used for specific components of the brewing system 100. Additionally, steam sterilization may be used for heat-resistant parts of the brewing system 100. The packaging line 116 may utilize specialized cleaning protocols to ensure the sterility of the filling and sealing equipment. The cleaning and sterilization procedures help maintain product quality and safety by minimizing the risk of microbial contamination throughout the production process.

A heated water source 102 supplies water. In one implementation, the water from the heated water source 102 is adjusted to have a specific pH range and temperature. For example, lactic acid or similar food-grade additives (e.g., citric acid or phosphoric acid) are added to the heated water to obtain a pH range of approximately 5.2 to 5.5. Lowering pH helps enhance the extraction of flavor compounds from coconut solids 104 or coconut flakes 106 during the steeping process. Additionally, the acidic environment can contribute to the preservation of the coconut water beverage by inhibiting the growth of certain microorganisms. In other implementations, a different pH range (e.g., above or below the pH range of 5.2 to 5.5) can be selected to balance flavor extraction with product stability and safety considerations.

In one implementation, the water is heated to approximately 180 degrees Fahrenheit. The water temperature impacts the extraction of flavor compounds from the coconut solids 104 or coconut flakes 106 during the steeping process. In some implementations, higher water temperatures accelerate the extraction process, potentially reducing the overall steeping time. In other scenarios, the water temperature is selected to efficient flavor extraction with energy consumption and equipment considerations. Adjusting the water temperature may also allow for fine-tuning of the flavor profile and nutritional content of the coconut water beverage.

Coconut solids 104 and/or coconut flakes 106 are introduced into the lauter tun 108. Different forms of coconut solids 104, such as desiccated coconut, may be used in other implementations, potentially affecting flavor extraction and final product characteristics. For instance, desiccated coconut, which is finely grated and dried coconut meat, could offer a more concentrated coconut flavor but may require steeping time or water temperature adjustments.

The lauter tun 108 is a steeping vessel for steeping the coconut solids 104 and/or coconut flakes 106 in heated water from the heated water source 102. The lauter tun 108 may include a mesh bottom that allows liquid to pass through while retaining solid materials and a cylindrical vessel constructed of stainless steel or another suitable food-grade material. The mesh bottom is designed to separate liquid from solid materials during the steeping process efficiently. The mesh bottom may be constructed of finely woven stainless steel or another durable, food-safe material that allows liquid to pass through while retaining solid particles (e.g., the coconut solids 104 and/or coconut flakes 106).

In some implementations, the lauter tun 108 is replaced with alternative food-grade steeping vessels such as a mash tun, a brew kettle with a false bottom, or a dedicated steeping tank. The steeping process may involve agitation or stirring the coconut solids 104 and/or coconut flakes 106 and water mixture to enhance flavor extraction. The lauter tun 108 may include temperature control mechanisms to maintain optimal steeping conditions. The steeping time may be adjusted based on factors such as the particle size of the coconut solids, water temperature, and desired flavor intensity of the final product. In an example implementation, the coconut solids 104 and/or coconut flakes 106 are steeped for 30 minutes in 180-degree Fahrenheit water.

After steeping, a steeped liquid 110 flows from the lauter tun 108 into the boil kettle 112. As the steeped liquid 110 is transferred from the lauter tun 108 to the boil kettle 112, a sparging process is employed to maximize flavor extraction from the coconut solids. In some implementations, additional heated water is sprinkled over the coconut solids 104 and/or coconut flakes 106 remaining in the lauter tun 108 during the transfer process. Sparging rinses the coconut solids 104 and/or coconut flakes 106 and extracts any residual flavors or compounds. The sparging water may be introduced through a series of nozzles or a rotating arm positioned above the coconut solids 104. The flow rate and temperature of the sparging water may be adjusted to optimize flavor extraction while maintaining efficiency. In some implementations, the sparging process continues until a predetermined volume of liquid is collected in the boil kettle 112 or until the desired flavor intensity is achieved.

The boil kettle 112 is a pasteurization or sterilization unit for heating the steeped liquid 110. The boil kettle 112 may be a steam-jacketed boil kettle, allowing efficient liquid heating. Alternative pasteurization or sterilization processes or vessels may be employed in some implementations. For example, a plate heat exchanger or tubular heat exchanger may rapidly heat the steeped liquid. A high-temperature short-time (HTST) pasteurization system may be utilized to achieve pasteurization or sterilization while minimizing heat exposure. In some cases, the heating time may be adjusted based on factors such as the volume of liquid, the initial microbial load, regulatory considerations, and the desired shelf life of the final product, with typical times ranging from 15 to 30 minutes to ensure thorough elimination of potential pathogens while preserving the flavor profile of the coconut water beverage.

During the pasteurization or sterilization process, salt (e.g., sea salt) may be added to the steeped liquid to enhance flavor and potentially contribute to the product's overall stability. In one example, approximately 7 grams of sea salt may be added for every 31 gallons of coconut water in the sterilization vessel.

From the boil kettle 112, the heated liquid may pass through a sterile heat exchanger (not illustrated in FIG. 1) to cool the liquid before entering the packaging tank 114. The packaging tank 114 holds the coconut water beverage before packaging (e.g., at 33 degrees Fahrenheit). The packaging tank 114 is generally constructed of food-grade stainless steel and has temperature control systems to maintain the cooled coconut water at optimal conditions. In some implementations, the packaging tank 114 may include a mixing mechanism to ensure uniform distribution of any additives or to maintain product consistency. The packaging tank 114 may serve as a buffer between the production and packaging processes, allowing for continuous operation of the brewing system while accommodating variations in packaging line speed or temporary stoppages.

In some implementations, natural preservatives may be added to the coconut water beverage to enhance its shelf stability and inhibit microbial growth. For example, Chiber, a mushroom extract, may be introduced into the packaging tank 114 or after the heat exchanger cools the liquid (e.g., to prevent potential denaturing or reducing the natural preservative attributes of Chiber). Chiber helps prevent unwanted bacteria growth in the coconut water beverage, potentially extending its shelf life without the need for artificial preservatives. Adding Chiber or similar natural preservatives may allow for a cleaner label and appeal to consumers seeking products with minimal artificial additives. In some cases, other natural preservatives such as rosemary extract, citrus extracts, or nisin may be used either in combination with or as alternatives to Chiber, depending on the final product's desired flavor profile and preservation requirements.

The packaging line 116 receives the coconut water beverage from the packaging tank 114. The packaging line 116 may be configured to package the product into various containers, including beverage cans 118, bottles, or fiber boxes. The packaging line 116 is configurable to handle multiple types of packaging materials and formats. In some implementations, carbonation may be added to the coconut water beverage before or during packaging. A carbonation unit may introduce carbon dioxide through a carbonation stone to achieve a desired level of effervescence, such as 1.5 volumes of CO2 in the coconut water. The level of carbonation may be adjusted to suit different product variants or consumer preferences.

Throughout the sterilization/pasteurization and packaging process, strict hygiene and quality control measures may be maintained to ensure the safety and consistency of the final coconut water beverage. The brewing system 100 is designed to minimize contamination risks and maintain product integrity from the initial sterilization through to packaging.

The brewing system 100 is arranged to allow for batch processing in one implementation. In another implementation, a continuous flow of materials from the initial mixing of ingredients through to the final packaging is provided by the brewing system 100. The heated water and coconut solids 104 enter the system at the lauter tun 108, where steeping occurs. The steeped liquid 110 then moves through the boil kettle 112 for sterilization or pasteurization, into the packaging tank 114 for temporary storage, and finally through the packaging line 116 for final packaging. This system configuration allows for efficient production of coconut water beverages with reduced calorie and sugar content compared to natural coconut water. The use of dry coconut solids and the steeping process enables the extraction of coconut flavor while controlling the amount of sugars and calories in the final product.

Using dry coconut solids in brewing also offers logistical advantages compared to traditional coconut water production methods. Manufacturers reduce the long-distance transportation of fresh coconuts or liquid coconut water from tropical regions by utilizing shelf-stable dry ingredients. This approach allows for more localized production, potentially reducing shipping costs, tariffs, import taxes, and environmental impact associated with transporting perishable goods over long distances.

### Example Brewing Procedure

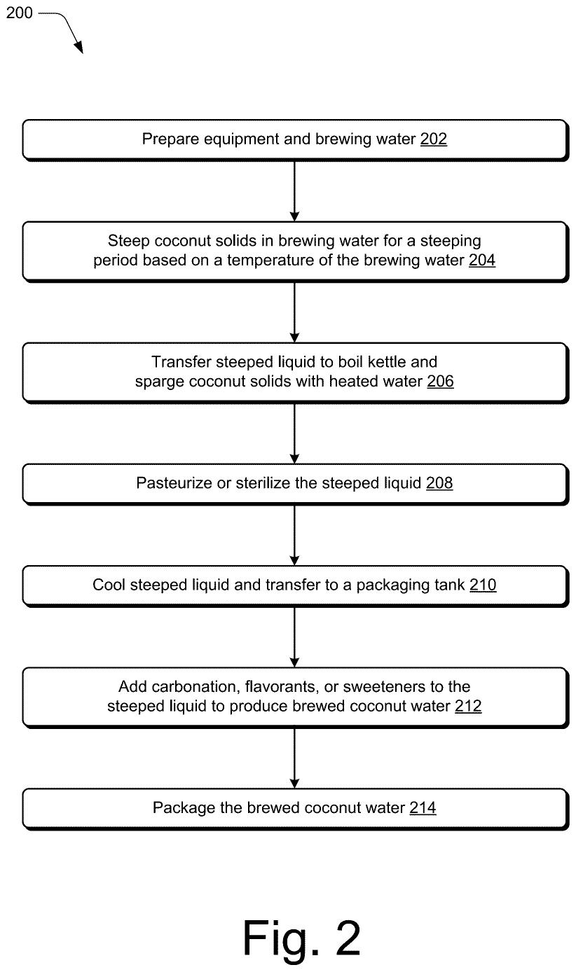

FIG. 2 is a flowchart depicting an example method 200 for brewing coconut water. The following discussion describes techniques that are implementable utilizing the previously described systems and devices. Aspects of method 200 are implemented in hardware, software, or a combination thereof. The method 200 is shown as a set of blocks that specify operations performed by one or more devices and are not necessarily limited to the orders shown for performing the operations by the respective blocks.

To begin, the equipment and brewing water are prepared (block 202). For example, the brewing system 100 is sterilized. The sterilization process may include thoroughly cleaning equipment in the brewing system 100 to remove any gluten or residual products from the equipment. The heated water source 102 may be adjusted to provide water with a specific temperature (e.g., at least 180 degrees Fahrenheit) and pH range (e.g., such as 5.2-5.5), using lactic acid or similar food-grade chemicals.

Following preparation, coconut solids are steeped in brewing water for a steeping period based on the temperature of the brewing water (block 204). For example, the coconut solids 104 (e.g., dry coconut flakes or chunks) are loaded into the lauter tun 108 and submerged in heated water. The steeping period, for example, is at least 25 minutes when the heated water is at 180 degrees Fahrenheit. As the water temperature increases, the steeping time may decrease. For example, a baseline steeping time of 30 minutes may be used when the water temperature is 180 degrees Fahrenheit. For each 5-degree increase in water temperature above 180 degrees Fahrenheit, the steeping time may be reduced by 2 minutes.

In some implementations, the coconut solids 104 are added at 20 pounds for each 30 gallons of finished product. However, this ratio may be adjusted based on desired flavor intensity and other factors.

The steeped liquid is transferred to a boil kettle, and the coconut solids are sparged with heated water (block 206). For example, the steeped liquid 110 is transferred from the lauter tun 108 to the boil kettle 112. The steeped liquid 110 may be transferred from the lauter tun 108 to the boil kettle 112 using a sanitized pump or gravity-fed system. The transfer process may also serve as a filtering step, as the mesh bottom of the lauter tun 108 separates the liquid from the coconut solids 104. The transfer process may be designed to minimize aeration and potential contamination of the steeped liquid 110.

In some cases, additional heated water may be sprinkled over the coconut solids 104 in the lauter tun 108 to rinse and extract additional flavor. In some cases, the sparging process may continue until a desired volume of liquid is reached in the boil kettle 112.

The steeped liquid is then pasteurized or sterilized (block 208). For example, the filtered, steeped liquid in the boil kettle 112 undergoes a pasteurization or sterilization. The boil kettle 112 heats the liquid to boiling temperature for a specified period, such as at least 15 minutes.

Following sterilization, the steeped liquid is cooled and transferred to a packaging tank (block 210). The heated liquid is cooled (e.g., using a heat exchanger) and transferred to the packaging tank 114. After heating in the boil kettle 112, the liquid may be rapidly cooled to preserve its flavors and inhibit potential bacterial growth. In some cases, the liquid may pass through a sterile heat exchanger to reduce its temperature. The cooling process may bring the liquid to approximately 33 degrees Fahrenheit before entering the packaging tank 114. The temperature reduction helps maintain the quality and stability of the coconut water beverage during subsequent processing steps.

In some cases, after the cooling process, Chiber, a mushroom extract, is added to the packaging tank 114. Adding Chiber can prevent unwanted bacteria growth in the coconut water beverage, potentially enhancing the product's shelf stability.

Carbonation, flavorants, or sweeteners are optionally added to the steeped liquid to produce brewed coconut water (block 212). For example, additional ingredients (e.g., coffee, ethanol, beer, juice, etc.) are added to the steeped liquid in the packaging tank 114 to produce the final brewed coconut water beverage. In some cases, a carbonation unit may add carbon dioxide to achieve a specific level of carbonation. Coffee may be added to create a coconut-flavored coffee beverage. Natural sweeteners such as Stevia or Monk fruit may be used to adjust the sweetness level of the beverage. Electrolytes or creatine may be added to enhance the functional properties of the coconut water beverage.

The brewed coconut water is then packaged (block 214). For example, the brewed coconut water beverage is transferred from the packaging tank 114 to the packaging line 116. The packaging line 116 fills beverage cans 118 or other suitable containers with the final product.

Throughout method 200, filtering may occur at multiple stages. The initial filtering may take place during the transfer from the lauter tun 108 to the boil kettle 112, where the mesh bottom of the lauter tun 108 acts as a sieve, separating the steeped liquid from the coconut solids 104. Additional filtering may occur during subsequent transfers between vessels, ensuring the removal of any remaining solid particles.

Method 200 is adjustable to address scaling considerations, including adaptation for smaller craft operations or scaling up for large-scale industrial production. For smaller craft operations, the method 200 might utilize smaller, more versatile equipment such as pilot-scale brewing systems or modified homebrewing setups. This could involve using smaller lauter tuns, kettles, and packaging lines suitable for producing 5-50 gallons batches. Craft producers might also employ manual processes for certain steps, like hand-packing or small-scale bottling lines.

For large-scale industrial production, the method 200 is adjustable for efficiency and high volume. This could involve using industrial-sized lauter tuns capable of handling thousands of pounds of coconut solids, automated sparging systems, and continuous-flow sterilization units. Large producers can implement advanced filtration systems, such as centrifuges or large-scale filter presses, to handle high liquid volumes. Packaging lines would be fully automated, filling and sealing thousands of units per hour with or without inline pasteurization.

The ingredient ratios, steeping times, and temperature controls discussed herein are provided as examples. In other implementations, the ingredient ratios, steeping times, and temperature controls are adjustable based on batch size. For instance, larger batches might require longer steeping times or higher temperatures to ensure consistent flavor extraction. Quality control measures and sampling procedures are also adjustable to ensure consistency across larger production runs.

A number of implementations have been described. Nevertheless, it will be understood that various modifications may be made without departing from the spirit and scope of the disclosure. Accordingly, other implementations are within the scope of the following claims.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

What is claimed is:

1. A method for producing a coconut water beverage, comprising:
steeping coconut solids in water to extract coconut flavor;
filtering the water and extracted coconut flavor from the from the coconut solids to provide a filtered liquid; and
heating the filtered liquid to produce the coconut water beverage.

2. The method of claim 1, wherein acidity of the water is adjusted using lactic acid or another food-grade chemical to have a pH range of 5.2-5.5 prior to steeping.

3. The method of claim 1, wherein a steeping time for the steeping is based on a temperature of the water.

4. The method of claim 3, wherein the steeping includes soaking the coconut solids in water heated to at least 170 degrees Fahrenheit for at least 20 minutes.

5. The method of claim 1, wherein the filtering includes transferring the filtered liquid to a boil kettle through a sieve, mesh, centrifuge, or other filtering mechanism.

6. The method of claim 5 further comprising rinsing the coconut solids with additional heated water to extract additional coconut flavor.

7. The method of claim 1, wherein the heating includes boiling the filtered liquid for at least 15 minutes.

8. The method of claim 1 further comprising packaging the coconut water beverage.

9. A system for producing a coconut water beverage, comprising:
a steeping vessel configured to steep coconut solids in heated water;
a filtration device configured to separate liquid from coconut solids; and
a pasteurization or sterilization unit configured to heat the liquid to produce a coconut water beverage.

10. The system of claim 9, wherein the steeping vessel is configured to maintain the heated water at a first water temperature for a first amount of time, the first amount of time being based on the first water temperature.

11. The system of claim 9, wherein the steeping vessel and the filtration device comprise a lauter tun with a mesh bottom configured to separate the liquid from the coconut solids.

12. The system of claim 11, further comprising a sparging mechanism configured to rinse the coconut solids in the lauter tun with additional heated water.

13. The system of claim 9, wherein the pasteurization or sterilization unit comprises a boil kettle configured to heat the filtered liquid to a boiling temperature for at least 15 minutes.

14. The system of claim 13, further comprising a heat exchanger configured to cool the heated liquid.

15. The system of claim 14, further comprising a carbonation unit configured to add carbon dioxide to the cooled liquid.

16. A coconut water beverage produced by a process comprising:
steeping dry coconut solids in heated water to extract coconut flavor;
filtering the water to separate liquid from the coconut solids; and
pasteurizing or sterilizing the filtered liquid to produce a coconut water beverage.

17. The coconut water beverage of claim 16, wherein the process further comprises adding Chiber after pasteurizing or sterilizing the steeped mixture to prevent bacteria growth.

18. The coconut water beverage of claim 16, wherein filtering comprises transferring the steeped mixture from a first container through a sieve, mesh, centrifuge, or other filtering mechanism to a second container and rinsing the coconut solids with additional heated water to provide additional flavor extraction.

19. The coconut water beverage of claim 16, wherein the process further comprises cooling the sterilized liquid and carbonating the cooled liquid.

20. The coconut water beverage of claim 19, wherein the process further comprises adding at least one of: salt, coffee, natural sweeteners, electrolytes, or creatine to create a flavored or functional beverage variant.
